(19) United States
(12) Patent Application Publication
(10) Pub. No.: US 2010/0142733 A1
(43) Pub. Date: Jun. 10, 2010

(54) Apparatus and Method for Generating Directional Sound

(76) Inventors: Jung-woo CHOI, Hwaseong-si (KR); Young-tae Kim, Seongnam-si (KR); Jung-ho Kim, Yongin-si (KR); Sang-chul Ko, Seoul (KR)

Correspondence Address: North Star Intellectual Property Law, PC, P.O. Box 34688, Washington, DC, 20043, US

(21) Appl. No.: 12/634,054

(22) Filed: Dec. 9, 2009

(30) Foreign Application Priority Data
Dec. 10, 2008 (KR) 10-2008-0125309

(51) Int. Cl. H04R 5/02

(52) U.S. Cl. 381/300

(57) ABSTRACT

An apparatus and method for generating directional sound are provided to output sound towards a specific sound zone. The apparatus includes an internal loudspeaker array having at least one sound source and edge loudspeakers, each with a sound source having directivity, located at respective ends of the internal loudspeaker array.

### CROSS-REFERENCE TO RELATED APPLICATION(S)

This application claims the benefit under 35 U.S.C. §119(a) of a Korean Patent Application No. 10-2008-0125309, filed Dec. 10, 2008, the disclosure of which is incorporated herein in its entirety by reference.

### BACKGROUND

1. Field

The following description relates to sound processing technology, and more particularly, to an apparatus and method for generating directional sound to be output to a specific sound zone.

2. Description of the Related Art

A sound generating apparatus such as typical loudspeakers cannot output directional sound, and output sound is spread out in all directions. That is, although a sound pressure level may vary depending on a position of a listener, sound is spread out around the sound generating apparatus.

Accordingly, the output sound may act as a disruption when delivered to a person who does not wish to hear it. Although the use of headphones or earphones may enable the output sound to be delivered to a specific listener, these may limit a movement of the listener and may even impair the listener's ability to hear other sound.

Accordingly, research has been underway to develop a technology to deliver sound only to a specific listener or a predetermined sound zone without using a separate device, such as an earphone or a headset. For example, a method has been proposed to control sound output directions of a plurality of sound sources for outputting sound having different phases, or to generate a uniform beam pattern for each frequency using a frequency-specific gain control filter. In this method, sound in a specific zone is amplified and other sounds are cancelled by adjusting interference between sound waves generated by the sound sources.

However, assuming the size of a specific sound zone is proportional to a wavelength of the sound, the size of the sound generating apparatus in such a method may need to increase. Also, the cost of the sound generating apparatus may increase as the apparatus likely need a plurality of sound sources having good efficiency in all frequency bands.

Meanwhile, sound sources for a high-frequency signal may be arranged at small intervals and a separate sound source for amplifying a low-frequency signal may be arranged at both ends of the sound source. However, this may not improve directivity of the sound and merely increase the quality of sound in a low-frequency band.

### SUMMARY

Accordingly, according to one general aspect, there is provided an apparatus and method for generating directional sound that improves directivity of sound by synthesizing output sound signals of an internal loudspeaker array and an edge loudspeaker cluster to remove output in side directions while maintaining directivity in a sound output direction.

According to another aspect, there is provided an apparatus to generate directional sound, including an internal loudspeaker array and edge loudspeakers. The internal loudspeaker array includes at least one sound source, and the edge loudspeakers are located at respective ends of the internal loudspeaker array, each of the edge loudspeakers including a sound source having directivity.

Each of the edge loudspeakers may include a plurality of edge loudspeakers.

The sound source of each of the edge loudspeakers may be a high-order directivity sound source.

The apparatus may further include a controller configured to control the internal loudspeaker array and the edge loudspeakers to remove output sound in predetermined directions, for example, side directions, while maintaining directivity of the output sound toward a specific direction by synthesizing sound signals output from the internal loudspeaker array and the edge loudspeakers.

The controller may include a filter configured to perform a high-frequency pass filtering or low-frequency pass filtering on an input sound signal, a signal processor configured to generate a multi-channel signal to deliver a high-frequency signal from the filter to the internal loudspeaker array and a low-frequency signal from the filter to the internal loudspeaker array or the edge loudspeakers, and a driver configured to receive the multi-channel signal and drive individual loudspeakers of the internal loudspeaker array and the edge loudspeakers.

Each of the edge loudspeakers may include a sound transducer to output sound waves having opposite phases forward and backward, a reflective plate located at a rear of the sound transducer, and a first blocking plate provided between a front portion and a rear portion of the sound transducer to increase an interference distance between a forward radiation sound from the sound transducer and a backward radiation sound of the sound transducer obtained where a sound wave output from the sound transducer is reflected by the reflective plate.

Each of the edge loudspeakers may further include a second blocking plate connected to the reflective plate and provided to cover an area on top of the sound transducer and/or an area at bottom of the sound transducer, to reduce directivity of sound waves output from the sound transducer in a vertical direction.

Each of the edge loudspeakers may further include a sound-absorbing member provided to the reflective plate and/or the first blocking plate.

According to still another aspect, there is provided a method for generating directional sound performed by a directional sound generating apparatus, the method including generating a sound signal for a directional loudspeaker and a sound signal for a non-directional loudspeaker, and supplying the sound signal for the non-directional loudspeaker to an internal loudspeaker array of the directional sound generating apparatus, the internal loudspeaker array comprising at least one sound source, and supplying the sound signal for the directional loudspeaker to edge loudspeakers of the directional sound generating apparatus, the edge loudspeakers being located at respective ends of the internal loudspeaker array.

The method may further include controlling the internal loudspeaker array and the edge loudspeakers to remove output sound in predetermined directions while maintaining directivity of the output sound toward a specific direction by synthesizing sound signals output from the internal loudspeaker array and the edge loudspeakers.

The controlling of the internal loudspeaker array and the edge loudspeakers may include performing a high-frequency filtering or low-frequency filtering on an input sound signal, generating a multi-channel signal to deliver a high-frequency signal to the internal loudspeaker array and a low-frequency signal to the internal loudspeaker array or the edge loudspeakers, and driving individual loudspeakers of the internal loudspeaker array and the edge loudspeakers.

Other features and aspects will be apparent from the following detailed description, the drawings, and the claims.

### BRIEF DESCRIPTION OF THE DRAWINGS

FIG. 1 is a diagram illustrating sound radiation patterns of an exemplary sound source clustering.

FIG. 2 is a graph showing sound radiation patterns of the sound source clustering of FIG. 1.

FIG. 3 is a graph showing sound radiation patterns where a high-order directivity sound source is used as an edge loudspeaker.

FIG. 4 is a graph showing sound radiation patterns in a case of internal loudspeakers and edge loudspeakers and in a case of synthesized sound where second-order directional transducers are used as edge loudspeakers.

FIG. 5 is a graph showing sound radiation patterns where non-directional transducers are used and where high-directivity transducers are used, for a sound signal at a frequency of 320 Hz.

FIG. 6 is a graph showing sound radiation patterns where non-directional transducers are used and where high-directivity transducers are used, for a sound signal at a frequency of 640 Hz.

FIG. 7 is a block diagram illustrating an exemplary apparatus to generate directional sound.

FIGS. 8A to 8D are diagrams for explaining exemplary arrangements of sound sources in an apparatus to generate directional sound.

FIGS. 9A to 9C are diagrams illustrating exemplary implementations of a high-directivity loudspeaker.

FIG. 10 is a block diagram illustrating an example of a controller in FIG. 7.

FIG. 11 is a flowchart illustrating an exemplary method for generating directional sound.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

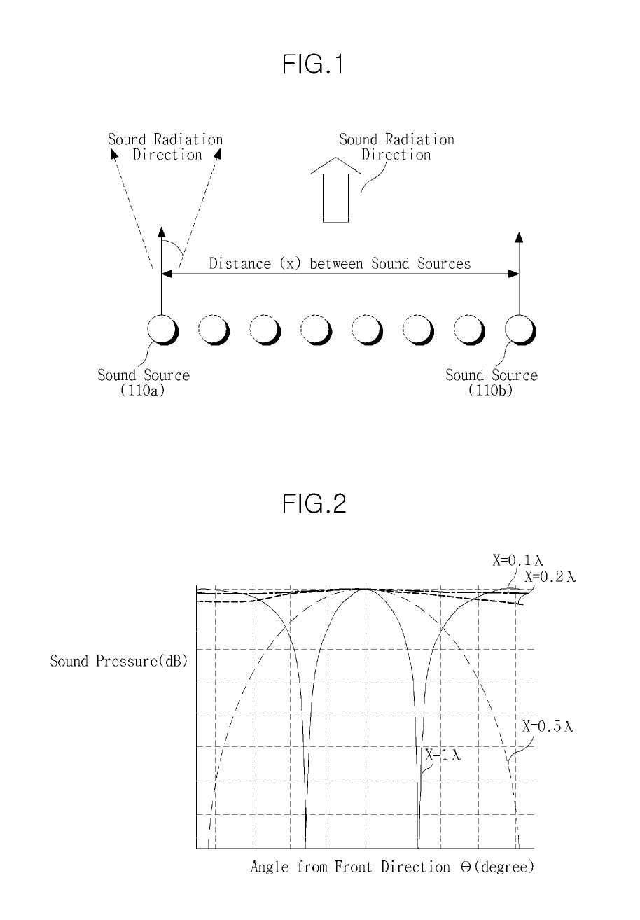

FIG. 1 illustrates sound radiation patterns of an exemplary sound source clustering.

Referring to FIG. 1, in a sound source array in which sound sources are arranged in a row, a pair of sound sources 110a and 110b spaced by the same distance from a center of the array may be defined as a sound source cluster. When a distance between the two sound sources 110a and 110b is x, directivity of sound radiation synthesized by the sound source clustering may be expressed as shown in Equation 1:

B(θ)=cos(π(x/λ)sin θ) [Equation 1]

where λ denotes a wavelength of sound and θ denotes an angle from a front direction from which the sound is radiated.

It can be seen from Equation 1 that the sharpest radiation pattern among radiation patterns of sound generated by sound source clusters, which include sound sources symmetrically spaced the same distance from the center, is generated by the sound source cluster 110a and 110b located at both ends of the sound source array.

FIG. 2 shows a graph illustrating sound radiation patterns of the exemplary sound source clustering of FIG. 1.

FIG. 2 shows sound pressure curves when distances x between two sound sources in a sound source cluster are 0.1, 0.2, 0.5 and 1 times the wavelength. It can be seen that the sharpest sound pressure curve is obtained when the distance x between the two sound sources is the greatest (one times the wavelength). That is, a sound pressure curve of the sound source cluster at the edges has a sharp main lobe at a center of the graph and side lobe values appear when the angle from a front direction increases.

In other words, it is discovered that the directivity increase as the distance x between the sound sources increases, and decreases as the distance x decreases.

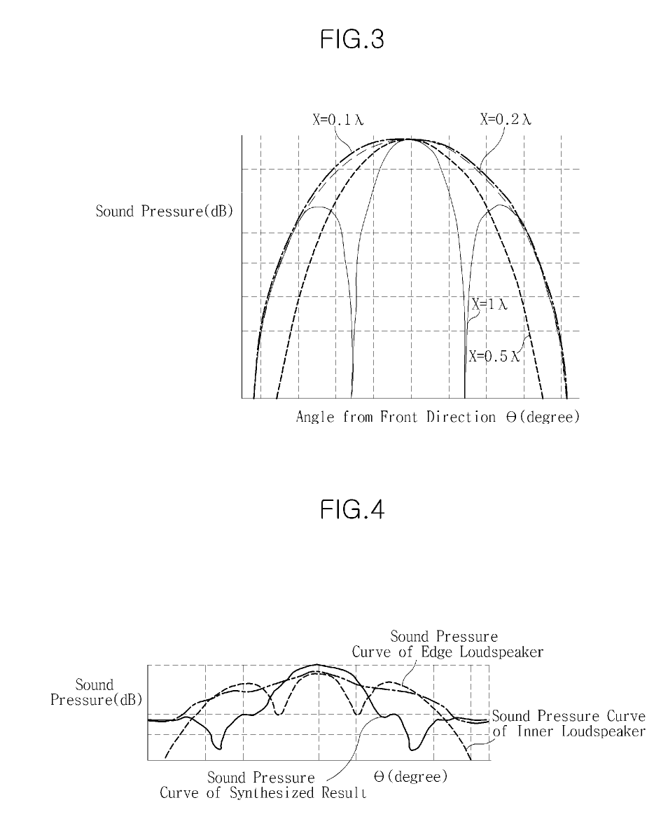

FIG. 3 shows a graph illustrating sound radiation patterns where a high-order directivity sound source is used as an edge loudspeaker.

Another exemplary sound source cluster may be configured by providing a high-order directivity sound source (transducer) at edges of a sound generating apparatus. The sound transducer may be designed to output sounds having opposite phases forward and backward. The number of pairs of the sound sources corresponds to an order, and a higher order structure is obtained where a structure to output sounds having opposite phases forward and backward is repeated.

When the directivity of each directional transducer is e(θ) and the directional transducer is used to constitute an edge loudspeaker cluster, directivity b′(θ) may be obtained as shown in Equation 2:

b′(θ)=b(θ)e(θ)=e(θ)cos(π(L/λ)sin θ) [Equation 2]

where L denotes a distance between two directional transducers. For example, FIG. 3 shows a sound radiation result where transducers having second-order cosine directivity (cos² θ) are used in the edge loudspeaker cluster. It can be seen that a main lobe width and a side lobe value decrease, unlike the case where transducers having no directivity are used in the cluster.

For example, the use of second-order directional transducers in which x corresponds to a 1/10 wavelength may provide a similar directivity compared to the use of non-directional transducers in which x corresponds to a ½ wavelength.

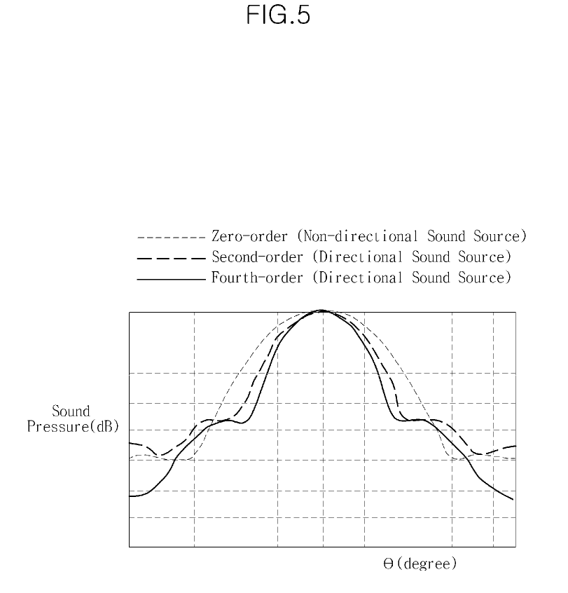

FIG. 4 shows a graph illustrating sound radiation patterns in a case of internal loudspeakers and edge loudspeakers and in a case of synthesized sound where second-order directional transducers are used as edge loudspeakers.

The edge loudspeaker cluster including the high-directivity transducers may be effective when an interval between the high-directivity transducers is similar to or smaller than the wavelength. This is because a main lobe and a side lobe of the sound radiation pattern generated by the edge loudspeaker cluster have opposite phases, as can be seen from Equation 2. Since a sound radiation pattern of the internal loudspeaker cluster having sound sources has the same phase at the main lobe and the side lobe, when the two patterns are coupled, the resulting pattern is enlarged at the main lobe due to the same phase and cancelled at the side lobes due to an opposite phase. That is, the side lobes are cancelled and the main lobe is amplified.

Thus, for example, the main lobe generated by the internal loudspeaker cluster has a narrow width and the side lobes are cancelled. Referring to FIG. 4, the side lobe is smaller than that of a typical sound source where an edge loudspeaker cluster uses high-directivity transducers. Accordingly, when a sound pressure radiation pattern generated by the internal loudspeaker cluster is coupled with a sound pressure radiation pattern generated by the edge loudspeaker cluster in a cancellation fashion, contribution of the edge loudspeaker cluster increases such that a sharper sound beam is obtained. As a result, a narrower sound pressure radiation pattern can be obtained than that of an array having non-directional sound source clusters.

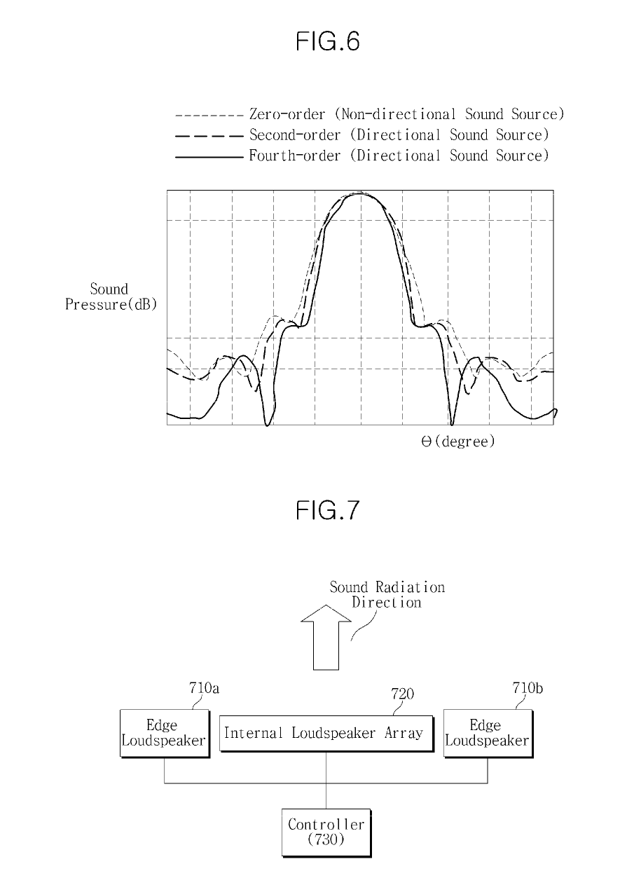

FIG. 5 shows a graph illustrating sound radiation patterns where non-directional transducers and where high-directivity transducers are used at edges of an array, for a sound signal at a frequency of 320 Hz, and FIG. 6 shows a graph illustrating sound radiation patterns where non-directional transducers and where high-directivity transducers are used at the edges of the array, for a sound signal at a frequency of 640 Hz.

Referring to FIGS. 5 and 6, it can be seen that where high-order directivity sound sources are used, a high-directivity synthesis result with a narrower main lobe and smaller side lobes is obtained than that of the case where non-directional sound sources or low-order directional sound sources are used, as described above.

Since an array size above one wavelength may not be needed in a high-frequency band, the sound from the high-directivity transducers located at the edges may be selectively muted and only the non-directional internal transducers may be driven. Thus, in a low-frequency band, a sharp sound beam can be implemented using the above-described effect of the high-directivity cluster, and in a high-frequency band in which a sufficiently small beam width can be implemented using a conventional technique, a narrow sound pressure radiation pattern can be obtained using only an internal loudspeaker array.

FIG. 7 shows an exemplary apparatus to generate directional sound.

The direction sound generating apparatus includes edge loudspeakers 710a and 710b, an internal loudspeaker array 720, and a controller 730.

The internal loudspeaker array 720 may include at least one sound source. The at least one sound source of the internal loudspeaker array may include typical sound transducer(s) having low directivity and generates sound having a wide directivity pattern.

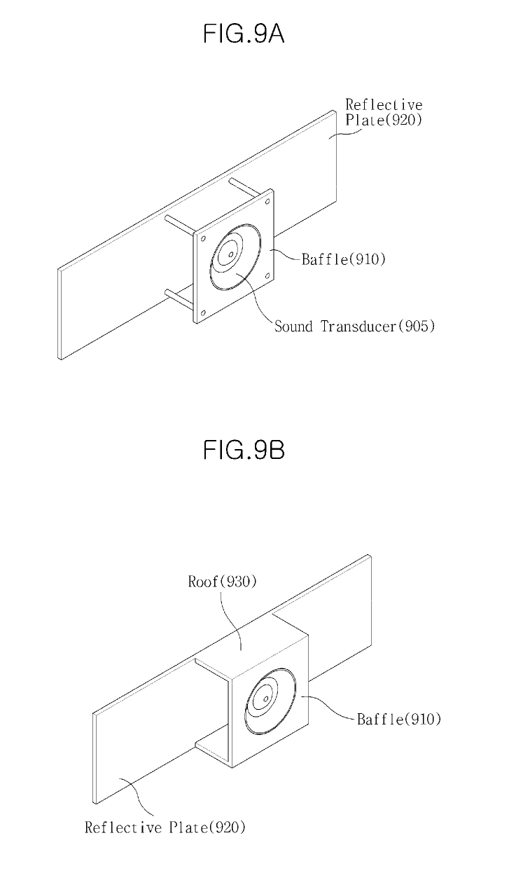

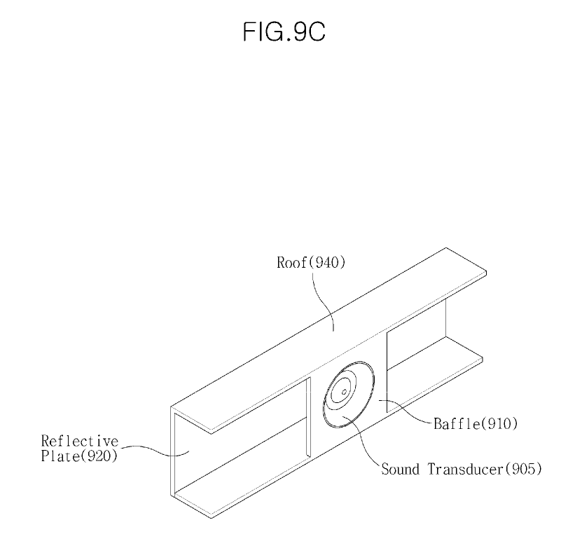

The edge loudspeakers 710a and 710b are located at ends of the internal loudspeaker array 720, respectively, and include a sound source having directivity. This sound source may be a sound transducer having high directivity in a center direction and a sound attenuation property in side directions. Each of the edge loudspeaker units 710a and 710b may include several directional transducers or one high-order directivity transducer. An example of high-directivity loudspeakers used as the edge loudspeakers 710a and 710b will be described later with reference to FIGS. 9A to 9C.

The controller 730 synthesizes output sound signals of the internal loudspeaker array 720 and the edge loudspeakers 710a and 710b, and controls the internal loudspeaker array 720 and the edge loudspeakers 710a and 710b to remove output in side directions while maintaining directivity of output sound. For example, the controller 730 performs signal processing to synthesize sounds generated by the edge loudspeakers 710a and 710b and the internal loudspeaker array 720 and remove side lobes while maintaining high directivity in a center direction.

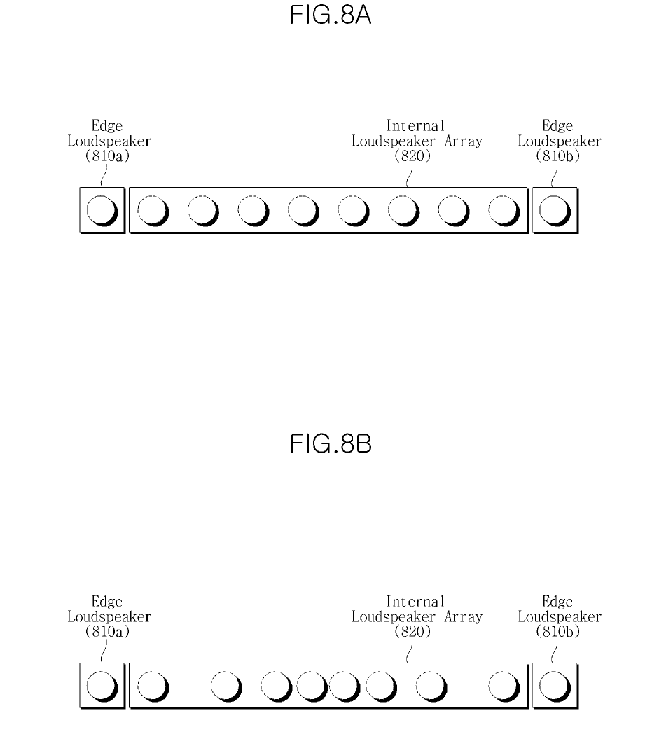

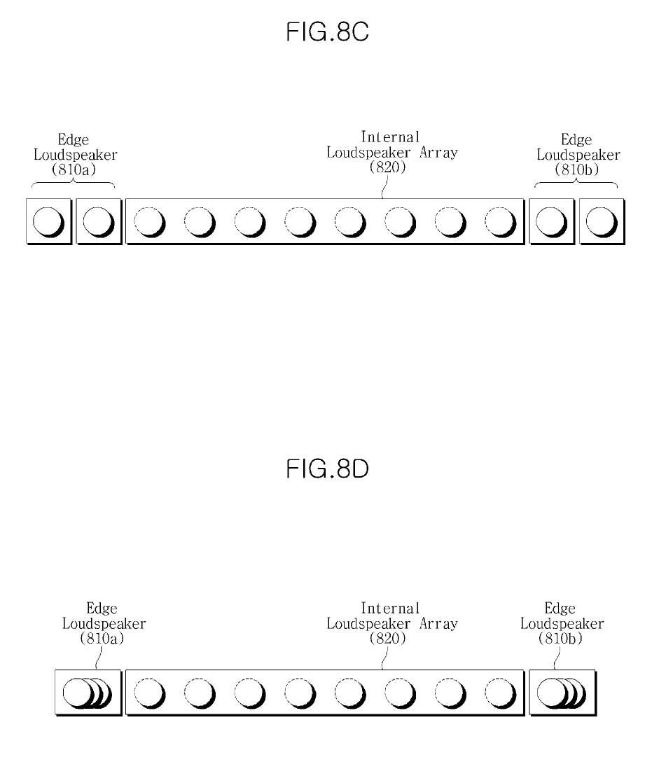

FIGS. 8A to 8D illustrates several exemplary arrangements of sound sources in an apparatus for generating directional sound.

A plurality of sound transducers (sound sources) may be arranged at the same intervals in an internal loudspeaker array 820, as shown in FIG. 8A. As another example, a plurality of sound transducers may be arranged at different intervals in the internal loudspeaker array 820, as shown in FIG. 8B. In other words, the sound transducers may be arranged at smaller intervals toward the center of the internal loudspeaker array 820 and at greater intervals towards the edge of the internal loudspeaker array 820.

Each of the edge loudspeakers 810a and 810b may comprise two or more edge loudspeakers, as shown in FIG. 8C. As further example, the edge loudspeaker may comprise high-order sound transducers, as shown in FIG. 8D.

FIGS. 9A to 9C illustrate several exemplary implementations of a high-directivity loudspeaker.

Referring to FIG. 9A, a baffle 910 is formed as a plate in parallel with a propagation direction of a sound wave output from a sound transducer 905. The baffle 910 is vertically and horizontally smaller than a reflective plate 920 and separates a front portion and a rear portion of the sound transducer 905. The size of the baffle 910 may depend on an enclosure size and a frequency property of the apparatus for generating directional sound. For example, when the baffle 910 is similar to or larger than the wavelength of the sound, a complex interference pattern may be generated and accordingly, the width of the baffle 910 may be designed to be smaller than a wavelength at the highest frequency in a low-frequency band of the sound.

It can be seen that the high-directivity loudspeaker may further include a roof 930 as a second blocking plate, as shown in FIG. 9B. The reflective plate 920 ideally has an infinite or much greater size than the wavelength in order to maximize a reflection effect. While it is impossible for the reflective plate 920 to have an infinite size, the reflective plate 920, with a finite size, may be provided to have directivity to obtain a desired performance irrespective of a position at which the apparatus for generating directional sound is installed.

A sound pressure should generally be changed with a horizontal movement in forming a specific sound area depending on the directivity. In other words, there may be no change with regard to a vertical direction, for example, a change of the sound pressure level according to a listener's height or posture, and a pressure level should be changed depending on the change in a horizontal distance to form the desired specific sound area.

Accordingly, in an exemplary implementation, a roof 940 is provided with upper and lower portions closed as shown in FIG. 9C to prevent destructive interference from occurring in a vertical direction, and opened in a horizontal direction. That is, the roof 940 is coupled to the reflective plate 920 and formed to cover the upper/top and lower/bottom sides of a sound transducer 905, so as to reduce directivity in a vertical direction of the sound wave output from the sound transducer 905. Thus, the size of the rear reflective plate 920 or volume of the sound transducer 905 may be reduced. In addition, by preventing the destructive interference in a vertical direction, a radiation sound pressure level may be increased.

It is understood that the roof 940 may be designed to partially or entirely block an area between the reflective plate 920 and the sound transducer 905.

It is also understood that the reflective plate 920 may further include a sound-absorbing member to absorb a high-frequency component, so as to prevent complex interference in a high-frequency band.

That is, it is understood that the baffle 910 or the roofs 930 and 940 may be implemented in several forms, and FIGS. 9A to 9C show only exemplary implementations. FIG. 9A illustrates an enclosure of the apparatus for generating directional sound including only the baffle 910 with no roofs, and FIGS. 9B and 9C illustrate enclosures of the apparatus for generating directional sound further including the roofs 930 and 940, respectively.

Again, the roof 930 may be implemented to partially block an area between the reflective plate 920 and the sound transducer 905 as shown in FIG. 9B, and the roof 940 may be implemented to entirely block an area between the reflective plate 920 and the sound transducer 905, as shown in FIG. 9C.

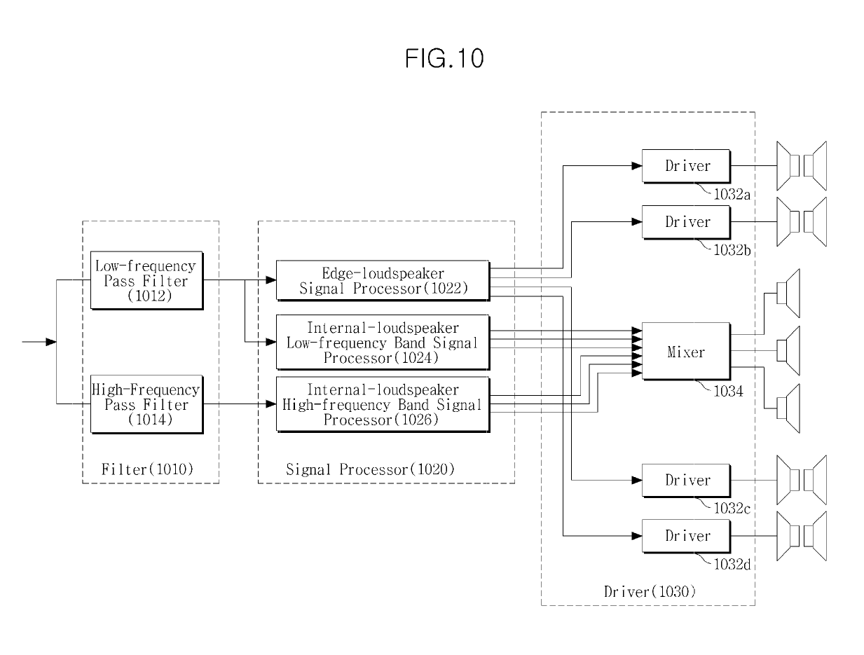

FIG. 10 illustrates an example of the controller 730 in FIG. 7.

The controller 730 includes a filter 1010, a signal processor 1020, and a driver 1030. The filter 1010 includes a low-frequency pass filter 1012 and a high-frequency pass filter 1014. The signal processor 1020 includes an edge-loudspeaker signal processor 1022, an internal-loudspeaker low-frequency band signal processor 1024, and an internal-loudspeaker high-frequency band signal processor 1026. The driver 1030 includes a plurality of drivers 1032a, 1032b, 1032c, and 1030d for driving the respective sound transducers, and a mixer 1034.

The filter 1010 performs high-frequency pass or low-frequency pass on an input sound signal. The low-frequency pass filter 1012 passes a low-frequency signal, and the high-frequency pass filter 1014 passes a high-frequency signal.

The signal processor 1020 generates a multi-channel signal to deliver the high-frequency pass signal to the internal loudspeaker array and the low-frequency pass signal to the internal loudspeaker array or the edge loudspeaker. For example, the edge-loudspeaker signal processor 1022 generates a low-frequency signal as a multi-channel signal and delivers the multi-channel signal to the drivers 1032a, 1032b, 1032c, and 1032d for the edge loudspeakers. The internal-loudspeaker low-frequency band signal processor 1024 generates a low-frequency signal as a multi-channel signal and delivers the multi-channel signal to the mixer 1034 to send it to each internal loudspeaker. The internal-loudspeaker high-frequency band signal processor 1026 generates a high-frequency signal as a multi-channel signal and delivers the multi-channel signal to the mixer 1034.

The driver 1030 receives the multi-channel signal and delivers it to the drivers to drive the internal loudspeaker array and the edge loudspeakers or to the mixer, so as to generate sound.

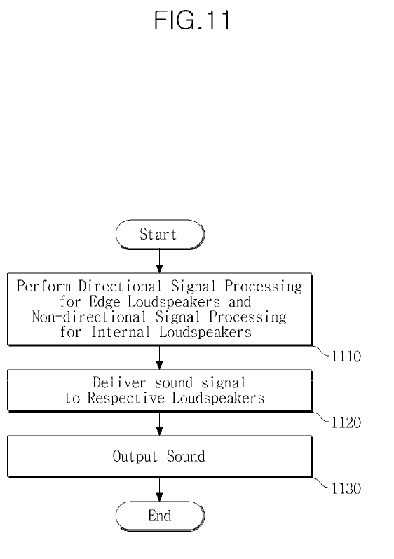

FIG. 11 is a flowchart illustrating an exemplary method for generating directional sound. The method may be performed by an apparatus for generating directional sound described above.

A directional sound signal and a non-directional sound signal are generated in operation 1110. That is, in operation 1110, sound signal processing for directional edge loudspeakers and sound signal processing for non-directional internal loudspeakers are performed. In operation 1120, a sound signal for the non-directional loudspeakers is supplied to an internal loudspeaker array having at least one sound source, and a sound signal for the directional loudspeakers is supplied to the edge loudspeakers located at ends of the internal loudspeaker array, wherein the directional loudspeakers includes a sound source having directivity. In operation 1130, the sound signals are synthesized and output.

For example, the output sound signals of the internal loudspeaker array and the edge loudspeakers are synthesized, and the internal loudspeaker array and the edge loudspeakers are controlled to remove output sound in side directions while maintaining directivity of the sound output toward a specific direction.

The edge loudspeakers may include a plurality of edge loudspeakers at both ends of the internal loudspeaker array. The sound source of the edge loudspeaker may be a high-order directivity sound source. The high-frequency pass filtering or the low-frequency pass filtering may be performed on the input sound signal, a multi-channel signal may be generated so that a high-frequency signal is delivered to the internal loudspeaker array and a low-frequency signal is delivered to the internal loudspeaker array or the edge loudspeakers, and each individual loudspeaker of the internal loudspeaker array and edge loudspeakers may be driven.

According to example(s) described above, a directional sound generating apparatus having a structure of a single array can concentrate sound in all frequency bands, for example, in a low-frequency band and a high-frequency band, on a specific sound zone. The apparatus may be provided so that only edge loudspeakers have directivity, so as to minimize the size of the apparatus.

Since a conventional structure and signal processing method may be used for an internal loudspeaker array, the directional sound generating apparatus may be implemented using a typical loudspeaker array.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa.

The computer-readable medium may be distributed among networked computer systems, and the program instructions or computer-readable codes may be stored and executed in a decentralized manner. Functional programs, codes, and code segments for implementing the methods described above may be easily inferred by programmers in the art to which the instant disclosure belongs.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus to generate directional sound, comprising:
an internal loudspeaker array comprising at least one sound source; and
edge loudspeakers located at respective ends of the internal loudspeaker array and each comprising a sound source having directivity.

2. The apparatus of claim 1, wherein each of the edge loudspeakers located at the respective ends of the internal loudspeaker array comprises a plurality of edge loudspeakers.

3. The apparatus of claim 1, wherein the sound source of each of the edge loudspeakers is a high-order directivity sound source.

4. The apparatus of claim 1, further comprising a controller configured to control the internal loudspeaker array and the edge loudspeakers so as to remove output sound in predetermined directions while maintaining directivity of the output sound toward a specific direction by synthesizing sound signals output from the internal loudspeaker array and the edge loudspeakers.

5. The apparatus of claim 4, wherein the controller comprises:
a filter configured to perform a high-frequency pass filtering or low-frequency pass filtering on an input sound signal;
a signal processor configured to generate a multi-channel signal to deliver a high-frequency signal from the filter to the internal loudspeaker array and a low-frequency signal from the filter to the internal loudspeaker array or the edge loudspeakers; and
a driver configured to receive the multi-channel signal and drive individual loudspeakers of the internal loudspeaker array and the edge loudspeakers.

6. The apparatus of claim 1, wherein each of the edge loudspeakers comprises:
a sound transducer to output sound waves having opposite phases forward and backward;
a reflective plate located at a rear of the sound transducer; and
a first blocking plate provided between a front portion and a rear portion of the sound transducer to increase an interference distance between a forward radiation sound from the sound transducer and a backward radiation sound of the sound transducer obtained where a sound wave output from the sound transducer is reflected by the reflective plate.

7. The apparatus of claim 6, wherein each of the edge loudspeakers further comprises a second blocking plate connected to the reflective plate and provided to cover an area on top of the sound transducer and/or an area at bottom of the sound transducer, to reduce directivity of sound waves output from the sound transducer in a vertical direction.

8. The apparatus of claim 6, wherein each of the edge loudspeakers further comprises a sound-absorbing member provided to the reflective plate and/or the first blocking plate.

9. The apparatus of claim 1, wherein the internal loudspeaker array comprises a plurality of sound sources arranged in the same intervals in a row or at increasingly smaller intervals toward a center of the internal loudspeaker array.

10. A method for generating directional sound performed by a directional sound generating apparatus, the method comprising:
generating a sound signal for a directional loudspeaker and a sound signal for a non-directional loudspeaker; and
supplying the sound signal for the non-directional loudspeaker to an internal loudspeaker array of the directional sound generating apparatus, the internal loudspeaker array comprising at least one sound source, and supplying the sound signal for the directional loudspeaker to edge loudspeakers of the directional sound generating apparatus, the edge loudspeakers being located at respective ends of the internal loudspeaker array.

11. The method of claim 10, further comprising controlling the internal loudspeaker array and the edge loudspeakers to remove output sound in predetermined directions while maintaining directivity of the output sound toward a specific direction by synthesizing sound signals output from the internal loudspeaker array and the edge loudspeakers.

12. The method of claim 11, wherein the controlling of the internal loudspeaker array and the edge loudspeakers comprises:
performing a high-frequency filtering or low-frequency filtering on an input sound signal;
generating a multi-channel signal to deliver a high-frequency signal to the internal loudspeaker array and a low-frequency signal to the internal loudspeaker array or the edge loudspeakers; and
driving individual loudspeakers of the internal loudspeaker array and the edge loudspeakers.

13. The method of claim 10, wherein each of the edge loudspeakers comprises an array of a plurality of edge loudspeakers.

14. The method of claim 10, wherein a sound source of each of the edge loudspeakers is a high-order directivity sound source.
